(19) United States
(12) Patent Application Publication
(10) Pub. No.: US 2007/0163391 A1
(43) Pub. Date: Jul. 19, 2007

(54) Decorative scissor handles and method for manufacturing decorative scissor handles

(76) Inventors: David L. Mathieu, Colchester, CT (US); Michael E. Peterson, Fairfield, CT (US)

Correspondence Address: WHYTE HIRSCHBOECK DUDEK S.C., ONE EAST MAIN STREET, SUITE 300, MADISON, WI, 53703-3300, US

(21) Appl. No.: 11/231,289

(22) Filed: Sep. 20, 2005

Related U.S. Application Data
(60) Provisional application No. 60/611,343, filed on Sep. 20, 2004.

(51) Int. Cl. B21K 11/00; B26B 13/00

(52) U.S. Cl. 76/106.5; 30/254

(57) ABSTRACT

A method for manufacturing decorative scissor handles and scissors made from the method are provided. A method for forming pattern parameters for molds for scissors handles is also provided. In a closed position, the handles resemble a design, such as a reindeer, a snowman, or any other desired design. The exterior surfaces of the handles can be decorated.

### CROSS-REFERENCE TO RELATED APPLICATIONS

This application claims priority under 35 U.S.C. § 119(e) to U.S. Provisional Patent Application No. 60/611,343, filed Sept. 20, 2004, the entirety of which is incorporated by reference herein.

### BACKGROUND OF THE INVENTION

This invention relates generally to scissors that employ molded handles. More particularly, this invention relates to scissors that employ molded handles having distinctive shapes.

Scissors having handles that are connected, joined and otherwise attached to metal cutting blades have long been known. The variety of shapes, configurations and dimensions for such handles is extensive. The cutting blades and handle arrangements have been widely adapted to address a number of useful specific cutting functions such as, for example, children's paper-cutting scissors, textile-cutting scissors, sewing scissors, kitchen scissors and numerous other scissors specific to useful applications.

### SUMMARY OF THE INVENTION

The invention is defined by the claims set out at the end of this disclosure. Methods for manufacturing decorative scissor handles are provided, along with scissors resulting from the methods. In one embodiment, the method includes defining first and second pattern parameters for first and second molds. A design is bifurcated into first and second handle portions partially defined by abutting generally linear edge portions. Each of the handle portions has a pivot tongue with an arcuate edge complementary to an abutting edge of the other handle portion. The pivot tongues are generally congruent and overlapping in a closed handle position.

A finger opening is formed in one of the handle portions, and a thumb opening is formed in the other handle portion. A first mold and a second mold are formed in accordance with the first and second pattern parameters.

The first and second molds are employed to make first and second handles. A first scissor component is formed and has a first blade and a first handle connected thereto. Likewise, a second scissor component is formed that has a second blade and a second handle connected thereto. The first and second scissor components are pivotally joined via the pivot tongues to form a pair of scissors positionable in a closed handle position.

In another embodiment, the method includes defining first and second design parameters. The parameters are designed by bifurcating a design into first and second handle portions partially defined by adjacent edge portions. Each of the handle portions has a pivot portion with an edge portion complementary to an abutting edge portion of the other portion. The pivot portions are generally congruent and overlapping in a closed handle position. A finger opening is formed in one of the handle portions, and a thumb opening is formed in the other handle portion. First and second handles are formed in accordance with the design parameters. A first scissor component is formed that has a first blade and a first handle connected thereto. Likewise, a second scissor component is formed and has a second blade and a second handle connected thereto. The first and second scissor components are pivotally joined at the pivot portions to form a pair of scissors positionable in closed handle position.

In another embodiment, a method for forming pattern parameters for molds for scissors handles is provided. A design is provided that has a first body portion and a second body portion that is larger than the first body portion. The first and second body portions are defined by an arcuate parting line. First and second pattern parameters for first and second molds are defined by dividing the second body portion into first and second handle portions with a dividing line that bisects the arcuate parting line. Each of the handle portions has a pivot tongue defined by the first body portion with an arcuate edge complementary to an abutting edge of the other handle portion. The pivot tongues are generally congruent and overlapping in a closed handle position. A first opening is formed in one of the handle portions, and a second opening is formed in the other handle portion to form the pattern parameters for the molds.

A first mold can be formed from the first pattern parameter, and a second mold can be formed from the second pattern parameter. The peripheral shapes of the molds are congruent.

The first and second molds can be employed to make first and second handles. A first scissor component can be formed that has a first blade and a first handle connected thereto. Likewise, a second scissor component can be formed that has a second blade and a second handle connected thereto. The first and second scissor components can be pivotally connected via the pivot tongues to form a pair of scissors positionable in a closed handle position

In all embodiments, in a closed position the handles resemble a design, such as a reindeer, a snowman, or any other desired design. The exterior surfaces of the first and second handle portions can be decorated.

### BRIEF DESCRIPTION OF THE DRAWINGS

Preferred exemplary embodiments of the invention are illustrated in the accompanying drawings, in which like reference numerals represent like parts throughout and in which:

FIG. 1 is a side view of a pair of scissors in the closed position illustrating a pair of scissors with decorative handles and that are manufactured in accordance with the method of the present invention;

FIG. 2 is a side view of the scissors of FIG. 1 in an open position;

FIG. 3 is an obverse view of the scissors of FIG. 1;

FIG. 4 is a first design, partly in schematic, which is the basis for the decorative handles of the scissors of FIG. 1;

FIG. 5 is a front side view of a thumb handle for the thumb handle component of the scissors of FIG. 1;

FIG. 6 is an obverse view of the thumb handle component of FIG. 5;

FIG. 7 is a front side view of the finger handle component for the scissors of FIG. 1;

FIG. 8 is an obverse view of the finger handle component of FIG. 1;

FIGS. 9A-9J show various side views of several different pairs of scissors manufactured in accordance with the present invention and illustrated in a closed position;

FIGS. 10A-10E show side views of various pairs of scissors manufactured and fully decorated in accordance with the method of the present invention and illustrated in a closed position; and

FIG. 11 is a second design, partly in schematic, which is the basis for the decorative handles of the scissors of FIG. 9G.

Before explaining embodiments of the invention in detail, it is to be understood that the invention is not limited in its application to the details of construction and the arrangement of the components set forth in the following description or illustrated in the drawings. The invention is capable of other embodiments or being practiced or carried out in various ways. Also, it is to be understood that the phraseology and terminology employed herein is for the purpose of description and should not be regarded as limiting.

### DETAILED DESCRIPTION

With reference to the drawings wherein like numerals represent like parts throughout the Figures, the manufacturing method is employed to manufacture molded handles that assume fanciful shapes and have decorative features as illustrated in the drawings. It should be appreciated that the drawings are merely illustrative of representative samples that may be provided by the manufacture of the method of the present invention.

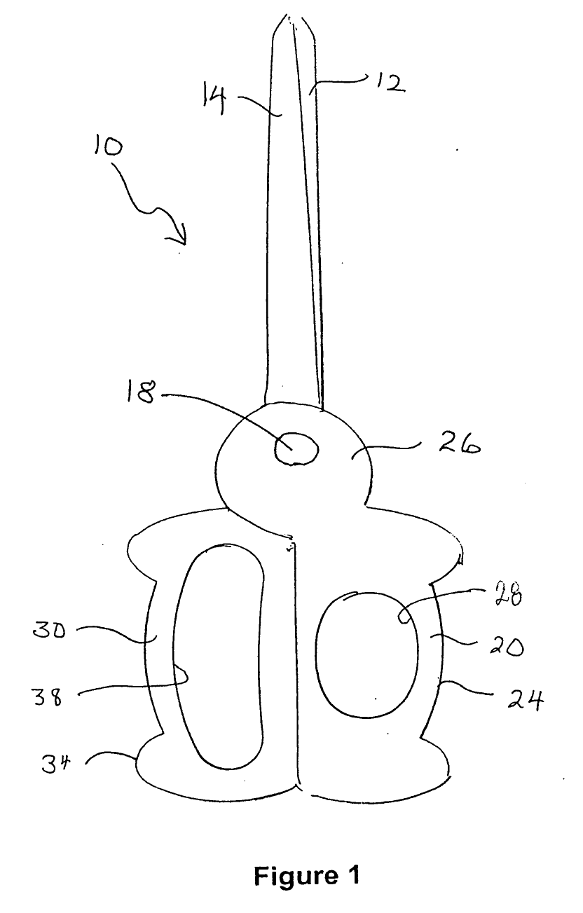

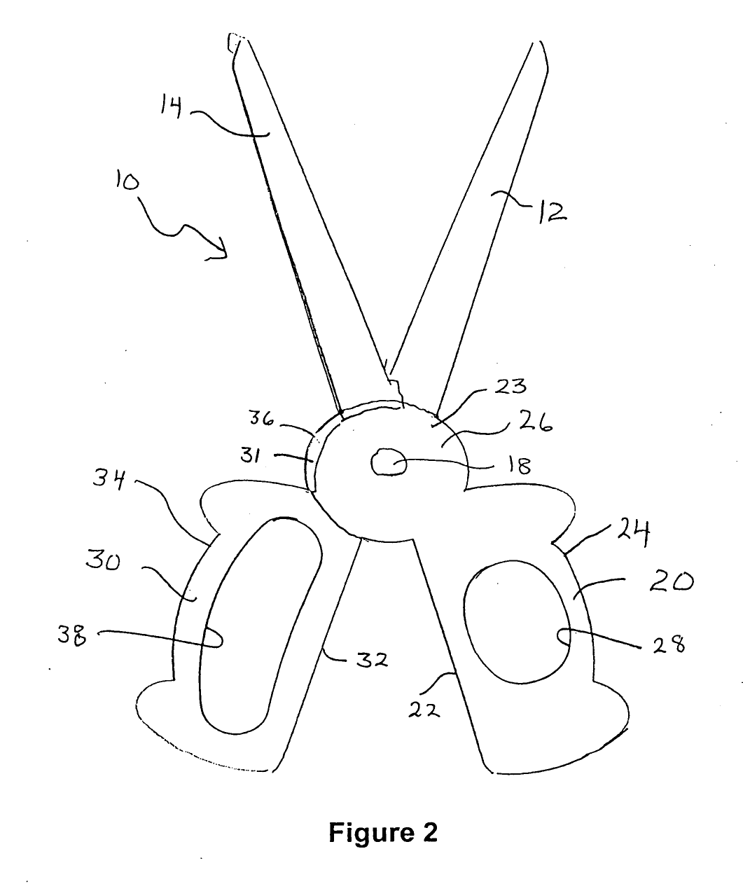

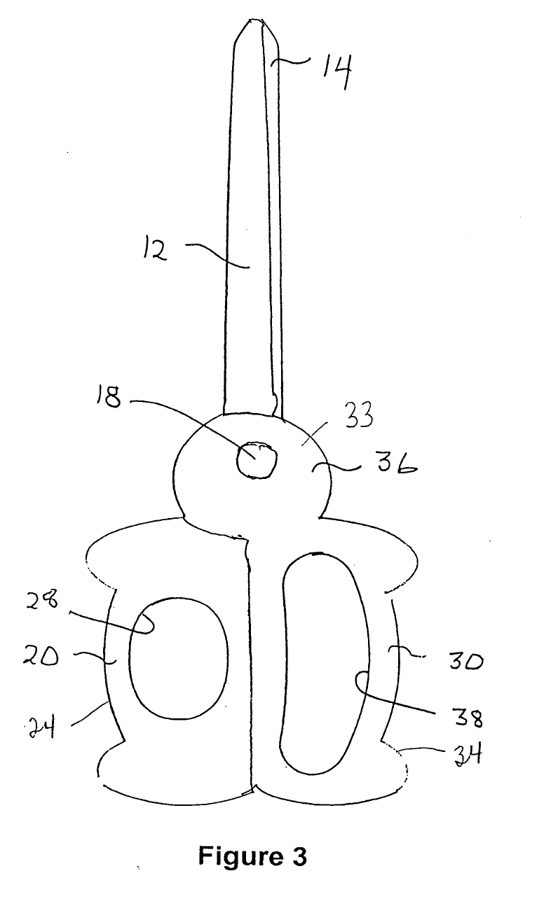

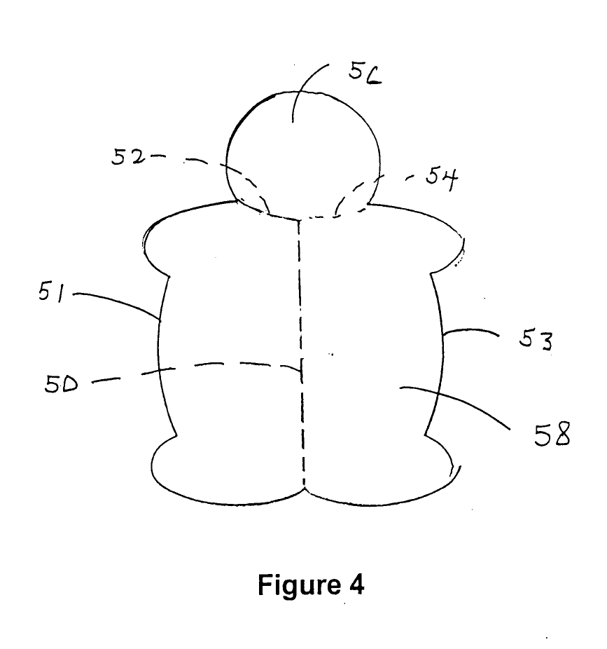

The invention may best be appreciated by reference to resulting molded handles for a first representative pair of scissors 10 illustrated in FIGS. 1-3 made from a mold pattern, such as the one shown in FIG. 4. The scissors 10 includes blades 12, 14, a thumb handle 20, and a finger handle 30. Each handle 20, 30 has a blade receiving pivot tongue 26, 36, respectively, at one end thereof. It should be noted that although the illustrated embodiments include a thumb handle 20 and a finger handle 30 of dissimilar sizes and shapes, the handles can also be of substantially similar sizes and/or shapes, such that the two handles can be used by a finger, e.g., a middle finger, and a thumb.

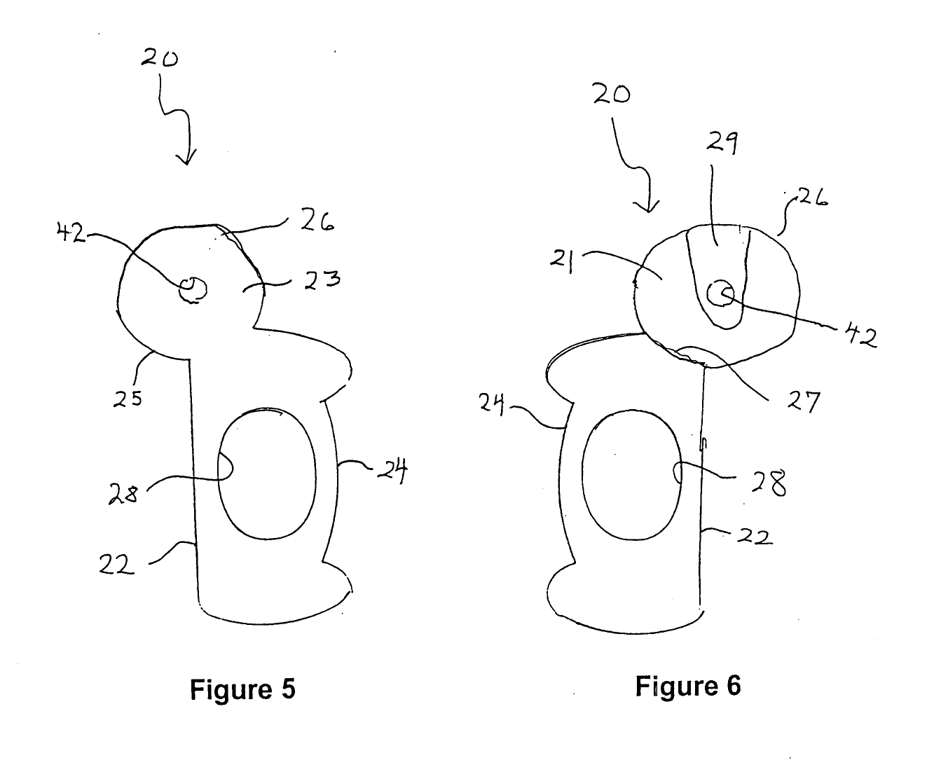

Referring now to FIGS. 5 and 6, the thumb handle 20 has a thumb opening 28, an inner handle edge 22, and opposing peripheral handle edge 24. The thumb opening 28 is sized to accommodate a thumb. Pivot tongue 26 has an inner surface 21 and an opposing outer surface 23.

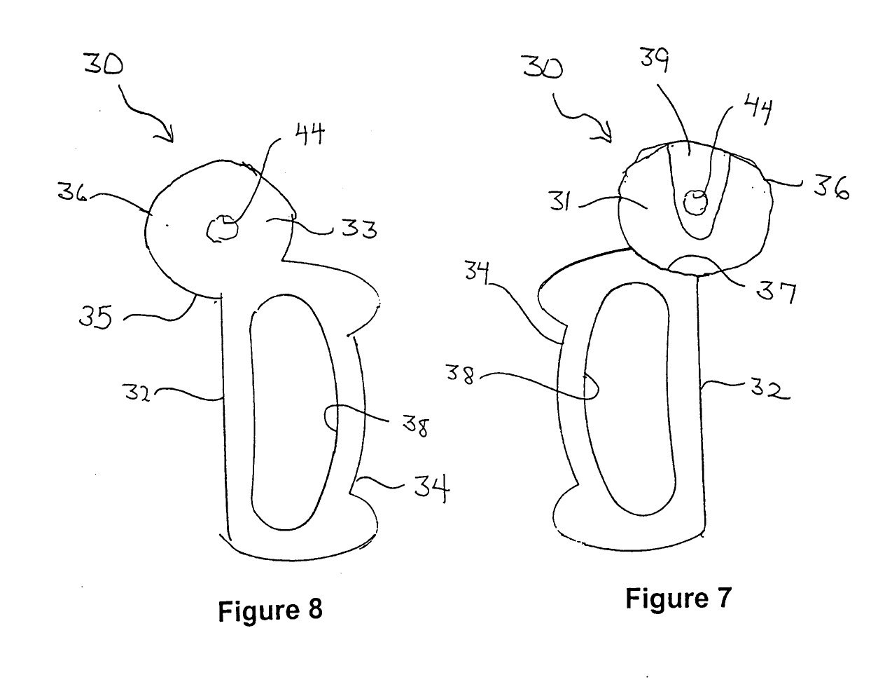

Referring now to FIGS. 7 and 8, the finger handle 30 includes a finger opening 38, an inner handle edge 32, and opposing peripheral handle edge 34. The edges 24, 34 can be beveled or contoured. The finger opening 38 is sized to accommodate one or more fingers.

Pivot tongue 36 has an inner surface 31 that faces the inner surface 21 of the pivot tongue 26 an opposing outer surface 33 that faces the outer surface 23 of the pivot tongue 26 when the scissors are assembled. Opposing interior portions of each of the tongues 26, 36 have a respective recess 29, 39 that is complementary with that of the respective pivot end portion of the blade for receiving the blades 14 and 12, respectively, so that the blades 12, 14 essentially overlap each other and are pivotal to present a cooperative shearing mechanism.

The inner surfaces 21, 31 and outer surfaces 23, 33 of tongues 26 and 36, respectively, are generally congruent. Consequently, the tongue recess 29 of the thumb handle 20 is complementary to the tongue recess 39 of the finger handle 30.

Each of the pivot tongues 26, 36 also include openings 42, 44 for receiving a pivot assembly 18, such as a pivot pin 18. In one embodiment, the pivot pin 18 has a molded head member (not shown). The pivot assembly 18 extends through aligned openings (not illustrated) of the cutting blades 14, 16. Pivot assembly 18 mounts the pivot tongues 26, 36 to each other for cooperative movement about the axis defined by pivot assembly 18. Pivot assembly 18 can also be a screw, nut and bolt, or any functional equivalent thereof.

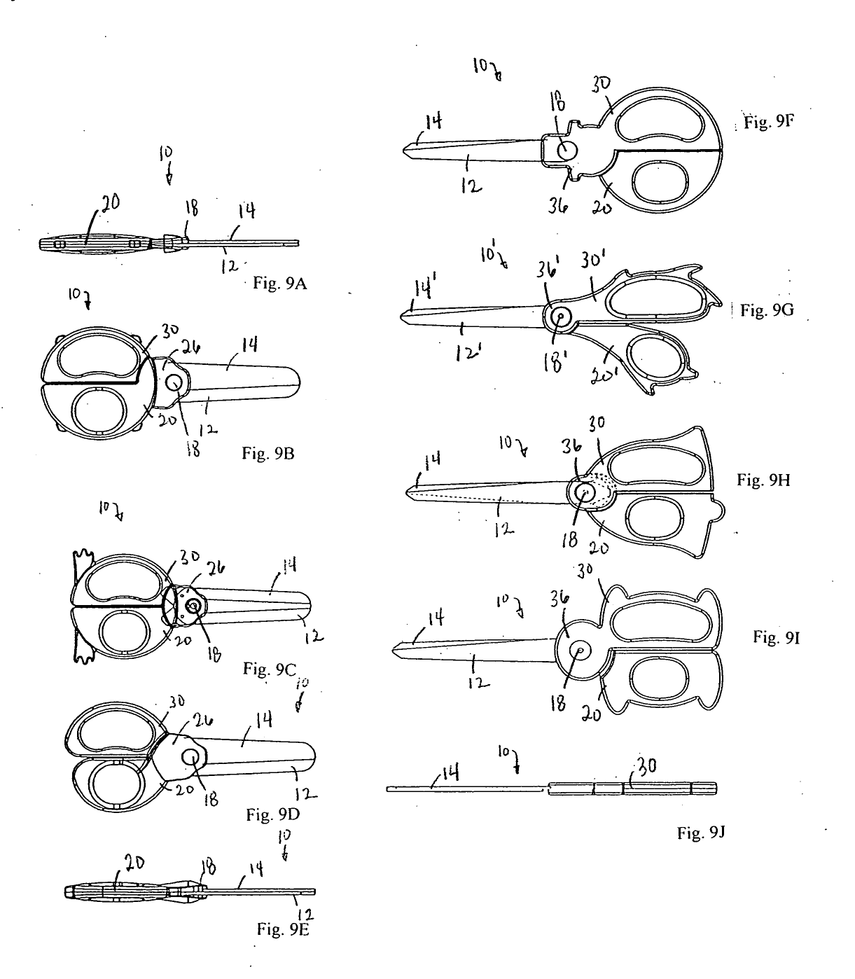

The manufacturing method involves constructing a first mold (not illustrated) for the thumb handle 20 and a second mold (not illustrated) for the finger handle 30. The molds are based on a design, such as the one shown in FIG. 4, as explained below. The molds are dimensioned and shaped to form a decorative object for a specific occasion, such as a gingerbread man in FIGS. 1-3 and FIGS. 9I-9J. FIGS. 9A-9H show additional exemplary scissors that can be manufactured: a turtle scissors in FIGS. 9A-9B, a frog scissors in FIG. 9C, a snake scissors in FIGS. 9D-9E, a snowman scissors in FIG. 9F, a reindeer scissors in FIG. 9G, and a bell scissors in FIG. 9H.

Referring back to FIG. 4, the mold patterns and hence the molded handles 20, 30 are formed by taking a basic figure and constructing a central generally linear dividing line 50 that bisects an arcuate bifurcated parting line 52, 54 that separates an upper body portion 56 of the design from a lower body portion 58. The representative design of FIG. 4 is axially symmetric or substantially axially symmetric with a reduced upper body portion 56 as compared to the lower body portion 58. However, other designs that can be used in the method are not axially symmetric or substantially axially symmetric, as is discussed below. The dividing line 50 defines the edges for the respective molds that in turn form the handle edges 22, 32, which abut when the handles are closed. The remaining design exterior periphery 51, 53 defines the corresponding peripheral handle edges 24, 34 produced by the molds.

The parting lines 52, 54 define edge 25 (FIG. 5) and edge 27 (FIG. 6) of substantially oval pivot tongue 26 that extends only around approximately three fourths of the upper portion of the mold for the thumb handle 20.

The molds are dimensioned to have a generally uniform thickness wherein the pivot tongues 26, 36 are roughly one half the thickness of the remaining handle defining portions. The molds are also configured to provide the respective thumb and finger openings 28, 38.

It will be appreciated that the thickness of the handles 20, 30 is substantially uniform except for the overlapping portions of the pivot tongues 26, 36 that are approximately one half of the thickness of the handles 20, 30 (except for the blade recesses 29, 39) and that overlap so that the corresponding combined tongue thicknesses are equal to that of the remainder of the handles 20, 30.

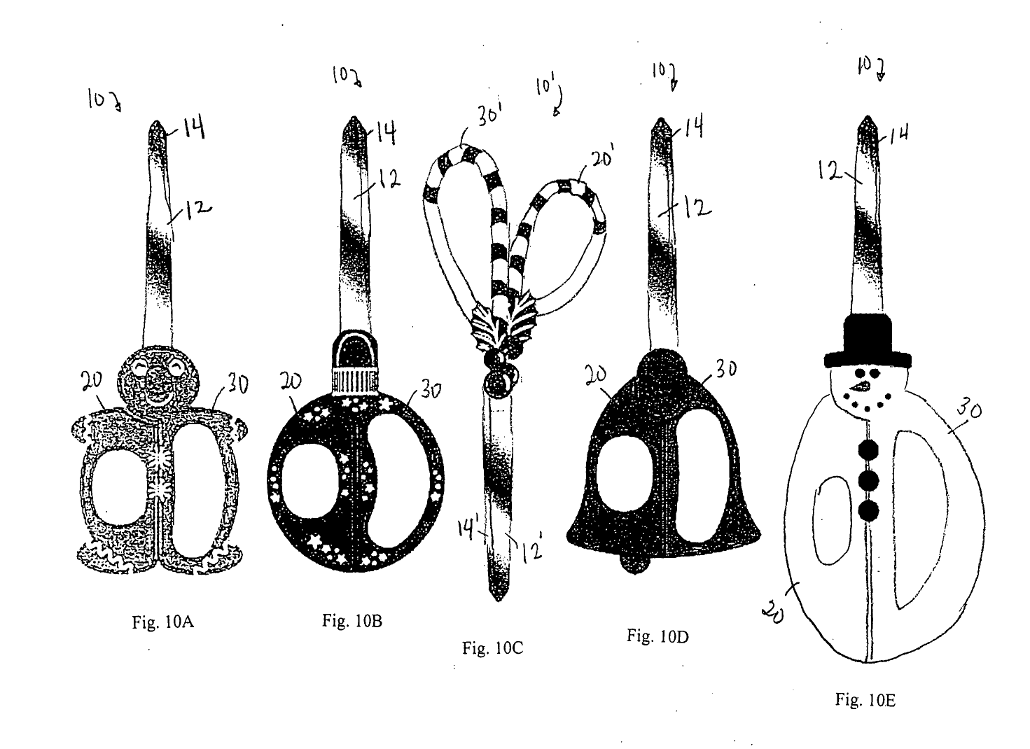

The molds are constructed to define the described handle characteristics. The handles are then molded such as by injection into the mold cavities of plastic material that is not tinted or colored of plastic material of a given tint or color. Molding can also be done by other techniques known in the art. After removal from the molds, the handles may also be decorated with various decorative indicia as illustrated in FIGS. 10A-10E to finish the handle designs. The handles may alternatively be formed by a process that does not involve molding.

The handles are preferably ultimately decorated as illustrated in FIGS. 10A-10E, showing a decorated gingerbread man scissors (FIG. 10A), a decorated ornament scissors (FIG. 10B), a decorated candy cane scissors (FIG. 10C), a decorated bell scissors (FIG. 10D), and a decorated snowman scissors (FIG. 10E).

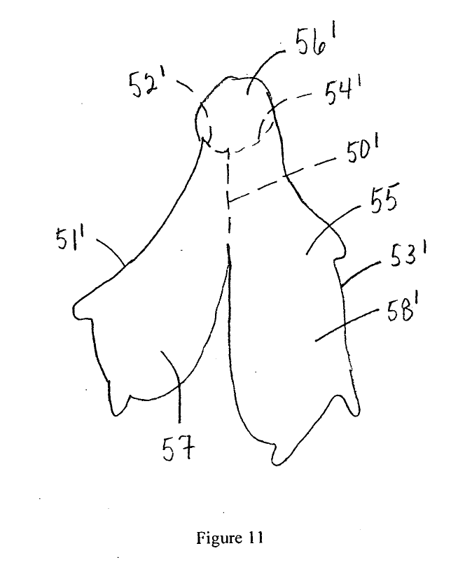

Referring now to FIG. 11, in another embodiment of the invention, the handle design is resolved into an upper body portion 56′ that is reduced relative to a lower body portion 58′ that is essentially enlarged relative to the upper body portion 56′. The upper body portion 56′ is separated by an arcuate parting line 52′, 54′ that forms the pivot tongue portions 26′, 36′ as previously described. The arcuate line 52′, 54′ is bisected by dividing line 50′, which defines the edges for the respective molds that in turn form the handle edges 22′, 32′, which can abut when the handles are closed. The remaining design exterior periphery 51′, 53′ defines the corresponding peripheral handle edges 24′, 34′ produced by the molds.

The mold parameters for the tongue portions 26′, 36′ will be overlapping and have substantially equal thickness and will be preferably congruent. In contrast to the earlier described embodiment, the enlarged lower portion 58′ of the body is subdivided into two distinct portions 55, 57 that need not be substantially symmetric such that they can form an asymmetric design, such as the candy cane scissors of FIG. 10C or the reindeer scissors of FIG. 9G. The molds are also configured to provide the respective thumb and finger openings 28,′ 38′ such that one portion 55′ forms a finger handle 30′ the other portion 57′ defines a thumb handle 20′. The patterns thus formed will be used to define the first and second handle molds as previously described.

It will be appreciated that the axial absolute symmetry is not required and that the edges need not abut for the thumb handle and the finger handle. Recesses for receiving the blade tangs or proximal ends can also be formed as well as transverse openings through the pivot tongue portions of the handles. Naturally, the handles may be decorated as previously described.

It is understood that terms such as “upper” and “lower” are for clarity sake only and are not limiting. Thus, an upper portion need not be above a lower portion, as it merely depends on orientation.

It is also understood that the various preferred embodiments are shown and described above to illustrate different possible features of the invention and the varying ways in which these features may be combined. Apart from combining the different features of the above embodiments in varying ways, other modifications are also considered to be within the scope of the invention. The invention is not intended to be limited to the preferred embodiments described above, but rather is intended to be limited only by the claims set out below. Thus, the invention encompasses all alternate embodiments that fall literally or equivalently within the scope of these claims.

What is claimed is:

1. A method for manufacturing decorative scissor handles comprising:
defining first and second pattern parameters for first and second molds comprising:
bifurcating a design into first and second handle portions partially defined by abutting generally linear edge portions, wherein each of the handle portions has a pivot tongue with an arcuate edge complementary to an abutting edge of the other handle portion, the pivot tongues being generally congruent and overlapping in a closed handle position;
forming a finger opening in one of the handle portions and
forming a thumb opening in the other handle portion;
forming a first mold and a second mold in accordance with the first and second pattern parameters;
employing the first and second molds to make first and second handles;
forming a first scissor component comprising a first blade and a first handle connected thereto;
forming a second scissor component comprising a second blade and a second handle connected thereto; and
pivotally joining the first and second scissor components via the pivot tongues to form a pair of scissors positionable in a closed handle position.

2. The method of claim 1, further comprising decorating exterior surfaces of the first and second handle portions, wherein in a closed position the handles resemble a design.

3. The method of claim 1, further comprising forming recesses to receive blade end portions in each of the molds.

4. The method of claim 1, wherein the peripheral shapes of the molds are congruent.

5. The method of claim 1, wherein the step of bifurcating comprises bifurcating the design into first and second handle portions that are substantially symmetric.

6. The method of claim 1, wherein the step of bifurcating comprises bifurcating the design into a first handle portion that is smaller than a second handle portion.

7. The decorative scissors formed by the method of claim 1.

8. A method for manufacturing decorative scissor handles comprising:
defining first and second design parameters comprising:
bifurcating a design into first and second handle portions partially defined by adjacent edge portions, wherein each of the handle portions has a pivot portion with an edge portion complementary to an abutting edge portion of the other portion, the pivot portions being generally congruent and overlapping in a closed handle position,
forming a finger opening in one of the handle portions and
forming a thumb opening in the other handle portion;
forming first and second handles in accordance with the design parameters;
forming a first scissor component comprising a first blade and a first handle connected thereto;
forming a second scissor component comprising a second blade and a second handle connected thereto; and
pivotally joining the first and second scissor components at the pivot portions to form a pair of scissors positionable in closed handle position wherein, the handles resemble the design.

9. The method of claim 8, further comprising decorating the exterior surfaces of the first and second handles wherein in the closed position the handles resemble the design.

10. The method of claim 8, wherein the step of bifurcating comprises bifurcating the design into first and second handle portions that are substantially symmetric.

11. The method of claim 8, wherein the first handle portion is smaller than the second handle portion.

12. The decorative scissors formed by the method of claim 9.

13. A method for forming pattern parameters for molds for scissors handles, the method comprising:
providing a design having a first body portion and a second body portion that is larger than the first body portion, the first and second body portions being defined by an arcuate parting line;
defining first and second pattern parameters for first and second molds comprising:
dividing the second body portion into first and second handle portions with a dividing line that bisects the arcuate parting line, wherein each of the handle portions has a pivot tongue defined by the first body portion with an arcuate edge complementary to an abutting edge of the other handle portion, the pivot tongues being generally congruent and overlapping in a closed handle position;
forming a first opening in one of the handle portions; and
forming a second opening in the other handle portion to form the pattern parameters for the molds.

14. The method of claim 13, further comprising:
forming a first mold from the first pattern parameter; and
forming a second mold from the second pattern parameter.

15. The method of claim 14, wherein the peripheral shapes of the molds are congruent.

16. The method of claim 14, further comprising:
employing the first and second molds to make first and second handles;
forming a first scissor component comprising a first blade connected to the first handle;
forming a second scissor component comprising a second blade connected to the second handle; and
pivotally joining the first and second scissor components via the pivot tongues to form a pair of scissors positionable in a closed handle position

17. The method of claim 16, further comprising decorating exterior surfaces of the first and second handle portions, wherein in a closed position the handles resemble a design.

18. The method of claim 13, wherein the step of dividing comprises dividing the second body portion into first and second handle portions that are substantially symmetric.

19. The method of claim 13, wherein the first handle portion is smaller than the second handle portion.

20. The decorative scissors formed by the method of claim 16.
